(19) United States
(12) Patent Application Publication
(10) Pub. No.: US 2011/0241826 A1
(43) Pub. Date: Oct. 6, 2011

(54) Reconfigurable Security Systems and Methods

(76) Inventors: James Dale Blackwell, Jr., Leonardtown, MD (US); Lionel Scott Blackwell, Leonardtown, MD (US)

(21) Appl. No.: 12/752,653

(22) Filed: Apr. 1, 2010

(51) Int. Cl. G05B 19/00

(52) U.S. Cl. 340/5.22

(57) ABSTRACT

Reconfigurable security systems, devices, and methods are provided. These can include systems having a configuration device, a reconfigurable lock system, and a reconfigurable key system, where transferable tumbler code carriers, having transferable tumbler codes, may be exchanged in order to provide controlled access to the devices or structures secured by the security system. By way of metaphor, the particular teeth configuration of a manual key may be understood as reflecting a single or fixed tumbler code. In embodiments, such a tumbler code may be exchanged, compared, and stored to allow for selective configuration of keys, mating of keys and locks, and selective access to security systems by a key system configured with a proper tumbler code.

### BACKGROUND

1. Technical Field

The present invention relates to programmable and reconfigurable security systems and methods. Programmable or transferable mechanical tumblers, electronic tumblers, or tumbler codes in various systems, methods, and articles of manufacture may be used to configure and reconfigure locks and other security systems for access by one or more corresponding key systems or key mechanisms.

2. Discussion

Locks and other security systems have been used for, among other things, preventing access by unauthorized users and controlling access by authorized users. Specific uses of locks are far reaching and include applications ranging from padlocks for securing lockers, deadbolts for securing doors, and mixed mechanical and electronic locks for securing motor vehicles. In these applications, when a user has a need to open the padlock, deadbolt, or motor vehicle, a specific key designed and cut to that particular lock is used by the user.

Electronic security systems, akin to a mechanical lock and key system, have use in network and computer applications. These electronic security systems can serve to block access to files, computers, or networks. In certain instances the electronic security systems can also serve to prevent certain tasks from being performed until a user provides a proper authorization password for access. This password may be verified by the security system prior to allowing access. Much like the more conventional lock and key system, if a user requires access to certain files, computers or networks, the user may be required to provide, at the required time, the appropriate password in order to gain access to the secure file, computer, or network.

### BRIEF DESCRIPTION OF THE DRAWINGS

FIG. 1 is a schematic of components of a reconfigurable security system in accord with embodiments of the invention.

FIG. 2 is a security bit string as may be employed in embodiments of the invention.

FIG. 3 is an array of security bit strings as may be employed in one or more components of a reconfigurable security system in accord with embodiments of the invention.

FIG. 4 shows tumbler code data arrays as may be used in one or more components of a reconfigurable security system in accord with embodiments of the invention.

FIG. 5 is a schematic view of an alterable key system that may be used in a reconfigurable system in accord with embodiments of the invention.

FIG. 6 is a schematic of an alterable lock system that may be used in a reconfigurable security system in accord with embodiments of the invention.

FIG. 7 is a schematic of a mechanical lock system that may be used in a reconfigurable security system in accord with embodiments of the invention.

FIG. 8 shows methods that may be employed in a reconfigurable security system in accord with embodiments of the invention.

FIG. 9 shows mated transferable tumbler code carriers in accord with embodiments of the invention.

FIG. 10 shows methods that may be employed using transferable tumbler code carriers in accord with embodiments of the invention.

### DETAILED DESCRIPTION

Embodiments of the invention include reconfigurable lock systems and reconfigurable key systems that may be used to secure and access various devices, systems, and networks. The lock systems and key systems of the various embodiments may include individual, pairs, sets, and groups of transferable tumbler code carriers that may be inserted into or otherwise communicate with a lock system or a key system, or both, for programming or configuring these systems. The key system may be used to open and close a lock system that contains or has been programmed with a transferable tumbler code that the key system also contains or has been programmed with.

In embodiments, should this transferable tumbler code be removed from the lock, the key system may no longer be able to open or close the lock. Should the transferable tumbler code carrier be inserted into a second lock, the key system may then be used to open and close this second lock. Thus, there may be an association between the key system and locks containing or programmed with the transferable tumbler codes and the carriers that contain them.

In embodiments, key systems, lock systems, security systems and the like may be initially programmed by or configured with a tumbler code carrier and then retain that programming for a set period of time, for a variable period of time, until a threshold is met or exceeded or until the key system, lock system, or security system is reprogrammed. The key system or lock system may be programmable by several tumbler code carriers without replacing or overwriting previously accepted tumbler code carriers and the tumbler codes therein. This programming may include inserting the tumbler code carriers into the key system, lock system, or security system and allowing codes on the carriers to be read from the carriers when access is requested or needed. The codes may also be transferred from the carriers to the lock system, key system, or other security system to program the lock or key system or other security system with the tumbler code, the carriers may then be subsequently removed once the codes are transferred.

The tumbler code carriers may be mated as pairs, where one tumbler code carrier may be used to configure a lock system or multiple lock systems and the corresponding tumbler code carrier of the pair may be used to configure a key system or multiple key systems. In so doing, a user may configure many locks with a tumbler code carrier such that a single key opens or provides access to each of the locks. These locks may also be configured to be opened or accessed with other keys as well. The locks may also be configured to provide access to only a single key as well.

The systems, methods, devices, and articles of manufacture consistent with embodiments of the reconfigurable security system may include security locks used in computer networks, conventional mechanical locks, motor vehicle ignition systems, and numerous other applications where access is controlled as well. A key system may be associated to several locks by using several transferable tumbler code carriers in the key system. Thus, a key system having five transferable tumbler code carriers, or five tumbler codes stored therein, may be able to open five different locks, where each of the locks contains a single transferable tumbler code carrier associated with one of the five tumbler codes accessible to the key system. In so doing, rather than carrying numerous keys for opening various objects, devices, and instruments, a user may carry a single key in order to open locks that have been configured with transferable tumbler codes, carriers or both that the key also contains.

Transferable tumbler code carriers for use in key systems and lock systems may be associated with one another through the use of a read/write configuration device. This device may be used to write code on transferable tumblers code carriers such that when the code is read by a lock system, the lock may be opened by a key associated with the same tumbler code. Mechanical means may also be used to associate a single key or multiple keys with multiple transferable tumblers. In mechanical means, the tumblers may be adapted to the keys and then removably inserted into locks that are intended to be opened by the key associated with the transportable tumblers.

In embodiments of the invention a lock system may contain multiple transferable tumbler code carriers, thereby allowing several different and distinct key systems to open or close the lock. Unique identifiers may be placed on the transferable tumbler code carriers to signify the identity of the keys or users that may be used to open the lock system. Other identifiers may be used as well.

In certain embodiments a lock system may not be opened unless multiple adaptable key systems and multiple transferable code carriers are used to open the locks. Thus, concurrent use of the codes of a transferable carrier code may be required based upon the programming of the lock system, the transferable tumbler code carriers inserted into the lock or both. In some embodiments, the transferable tumbler code carriers may remain with the lock systems while in others, the transferable tumbler code carriers may be inserted into lock system and then subsequently removed for use in a different lock system. This insertion and removal may perform a programming of the lock system to accept the tumbler code associated with the transferable tumbler code carrier. Other methods may also be used to transfer the tumbler codes between and from the carriers.

Embodiments of the security system may be used in an automobile setting where the Electronic Control Unit (ECU) of the automobile may be adapted to accept or communicate with the transferable tumbler code carrier or a tumbler code in order to unlock the car when signals from the adaptable key system are received by the ECU. Another example may include using a transferable tumbler code carrier, lock and key system to access a public building. When the security system receives an appropriate signal, the building may grant access because the received tumbler code has already been associated with the building security system. The alterable key system, which can include transmitter devices such as cell phones, may be used to unlock or open other security systems or locks as well. Further, locks used in hotels or other secure areas that are rented for short periods of time, may also be configured to accept transferable tumbler carrier codes such that the locks may be opened by a key system in accord with the present invention. In this particular embodiment, the lock may be configured to conform to the transferable tumbler code of a guest for only the period time in which the guest is visiting the hotel. The lock system may be further configured to allow access to physical keys or to transferable tumbler codes that the hotel staff may themselves be using to access the mom. Thus, in embodiments a single alterable key system may be used to lock or gain access to motor vehicles, office buildings, hotel moms, private dwellings, and computers. This flexible and potent access ability may be governed or managed according to specific criteria or targets, where the access criteria may differ between the various lock systems for which an alterable key system may be used.

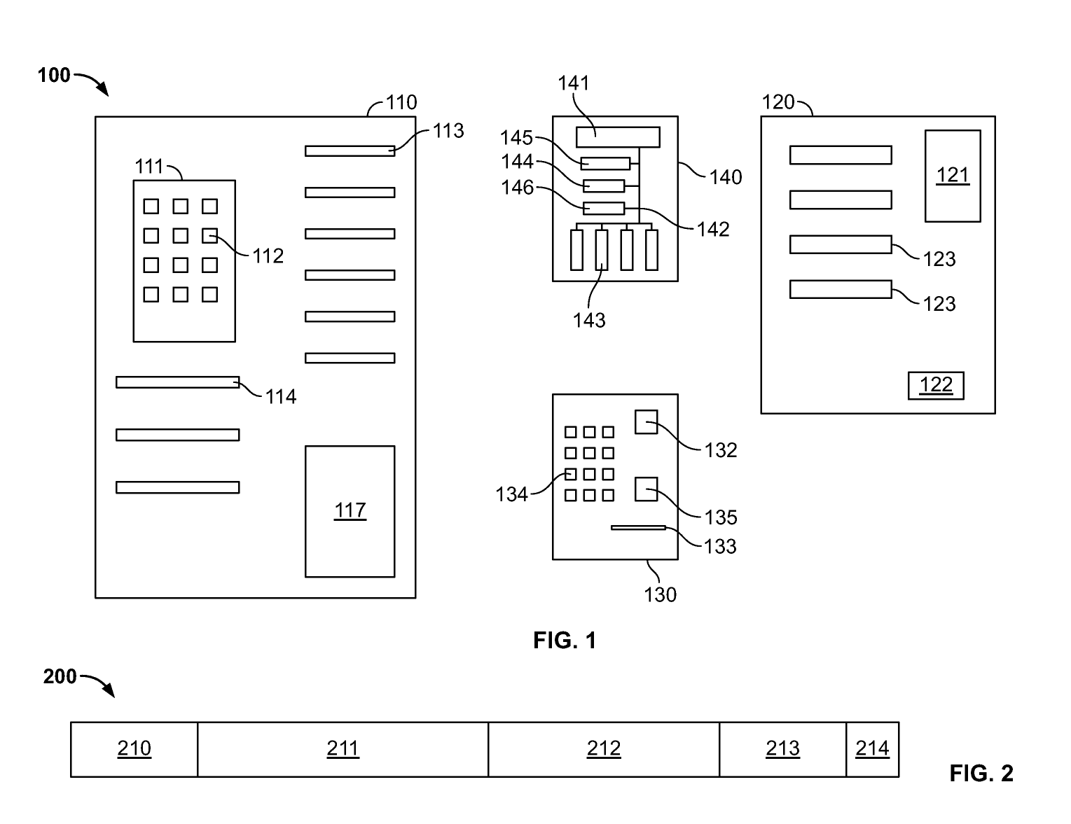

FIG. 1 shows a schematic of an embodiment of a security system 100 in accord with the present invention. Visible in FIG. 1 are tumbler code configuration device 110, transferable tumbler code carrier 140, reconfigurable lock system 120, and reconfigurable key system 130. The configuration device 110 may be used to configure the transferable tumbler code carrier 140 for use in the reconfigurable key system 130 or in the reconfigurable lock system 120. The transferable tumbler code carrier 140 may be used to transfer tumbler codes or other codes to and from the lock system 120 and the key system 130 as well as other devices. The transferable tumbler code carrier 140 may also be referred to as a transferable key code carrier, a master transferable tumbler code carrier and a satellite transferable tumbler code carrier. The transferable tumbler code carrier 140 is shown as having control logic 145, memory 141, encryption logic 144, I/O logic 146, contacts 143, and a bus 142 in communication with each of these sub-components. There may be other designs of the transferable tumbler code carrier as well, which may include embodiments that are implemented as computer processes and embodiments that exist as computer program products consisting of information stored on computer readable media.

The configuration device 110 may have a user input 111 with push pads 112. The configuration device 110 may also have communication ports 113 and 114 for inserting, swiping, holding, passing or retaining transferable tumbler code carriers for programming, read/write, etc. Electronic control system 117, may control the configuration device 110 and may itself, along with the configuration control device 110, include memory, a processor, a power source, and an input/output means. The configuration device 110 may configure and store in nonvolatile memory of the carriers 140: codes; bit strings; and, data arrays, which may be used by reconfigurable key systems 130 and reconfigurable locks systems 120 practicing embodiments of the security system.

The key system 130 may include port 133, or multiple ports like port 133, for receiving the code carrier 140 as well as touch pads 134 for operating the key system 130 and an interface 132 for communicating with a lock system 120. The interface 132 may be a wireless interface as well as a wired or contact interface where communication and opening and closing may occur once contact is made between a key system and a lock system. Other interface technologies, including optical and sonic interfaces may also be used. The key system 130 may further include an electronic control system 135.

The lock system 120 may include ports 123, which may be used to accept, read, write to, and possibly store transferable tumbler code carriers 140. The lock system 120 may also include an electronic control system 121 and a lock control 122. The electronic control system 121 may be used to read from or write to the transferable tumbler code carriers, store information therefrom and place information thereon. The electronic control system 121 may also serve to control the lock system 120 and I/O to and from the lock system 120. The lock control 122 may be configured to access or control a mechanical locking mechanism managed by the lock system 120 as well as other locking methodologies. These locking mechanisms and locking methodologies can include deadbolts, pin and tumblers, and electronic code matching and encryption. Moreover, like the key system, the lock system may contain an interface that may be a wireless interface as well as a wired or contact interface where communication and opening and closing may occur once contact is made between a key system and a lock system. Other interface technologies, including optical and sonic interfaces may also be used. Still further, manual inputs, such as with key pads, may be used to interface with the lock system.

The lock system 120 may be configured with and running code, which when executed, causes the lock system 120 to open and close whenever a reconfigurable key system associated with a tumbler in one of the ports 123 of the lock serves to authorize an opening of the lock system 120. This authorization may include matching tumbler codes in the key system 130 and the ports 123. The tumbler codes may be from carriers 140 in the ports 123 as well as from bit strings of carriers 140 previously communicated to the lock system 120. A matching tumbler code authorization may also include other criteria as well. For example, the number of times a key has been used may be considered as well as the time of day, the day of the week, and the number of times the lock system 120 itself has been opened. The communication between the key system 130 and the lock system 120 may be wireless, through a wired link (electrically or optically), or via direct contact.

As mentioned above, the security system 100 may be used to open or gain access to various locks or secure systems. These can include and are not limited to automobiles, construction equipment, aircraft, computer networks, telecommunication networks, wide-area networks, buildings, lockable structures, toolboxes, and other secure areas.

FIG. 2 shows a security bit string 200 as may be used in embodiments of the present invention. The bit string 200 may be used when transferring access codes or reviewing access codes in embodiments of the present invention. These access codes may be written to the transferable tumbler code carriers 140 by a configuration device 110. The bit string 200 may be stored locally in nonvolatile memory of the transferable tumbler code carriers 140 by the configuration device 110. This bit string 200 may be accessed and read by the key system 130 or the lock system 120 in which the transferable tumbler code carrier is inserted. The bit string may be protected from transfer from the nonvolatile memory of the transferable tumbler such that access to a lock system or use of a key system may only occur if the bit string is read from the transferable tumbler code carrier. Other adaptations may also be possible.

The security bit string 200 of FIG. 2 is shown with several sections including a header section 210, access criteria 211, tumbler code 212, encryption key field 213, and footer section 214. The header section 210 and footer section 214 may be used to designate the location and length of the bit string as well as its date of creation, expiration date, and other information directed to the bit string 200 itself. The access criteria 211 may contain data directed to limitations that may be placed on the use or operation of lock systems being accessed with the bit string. For example, the access criteria may limit the time of day in which the particular bit string may be used to open the lock system or the length of time in which the lock system may remain open. Other variables can include the number of times a lock may be opened by a particular bit string, the amount of time between opening cycles for the lock system, and the scope of access a user of a particular bit string is entitled to. The tumbler code 212 can be the particular code that must be matched by the lock system reading the bit string 200 before the lock will open. This tumbler code can be encrypted with 64 and 128 bit encryption schemes as well as other encryption schemes. Still further, a rolling tumbler code scheme may be used, where lock systems use an existing tumbler code to grant access and then send a replacement tumbler code to be used the next time access is sought.

The encryption key field 213 may be used to encrypt the tumbler code 212 in addition to or instead of other encryption schemes. The encryption key field 213 can include instructions for providing hash or other encryption methodologies to the tumbler code 212 such that the code may be protected from unauthorized copying, reading, and review. For example, if the tumbler code 212 is copied from the transferable tumbler code carrier 140 or the security bit string, the absence of the encryption key would render the tumbler code 212 unusable.

In some embodiments the encryption key may be located in a separate bit string to increase the security associated with the tumbler code. Absent the encryption key, which is not located in the same bit stream, the tumbler code would not function or would be unusable. Security may be increased by providing several encryption keys for each tumbler code where only one encryption key would work or would be unusable at a given time. Other methodologies for increasing the security of the tumbler code may also be used.

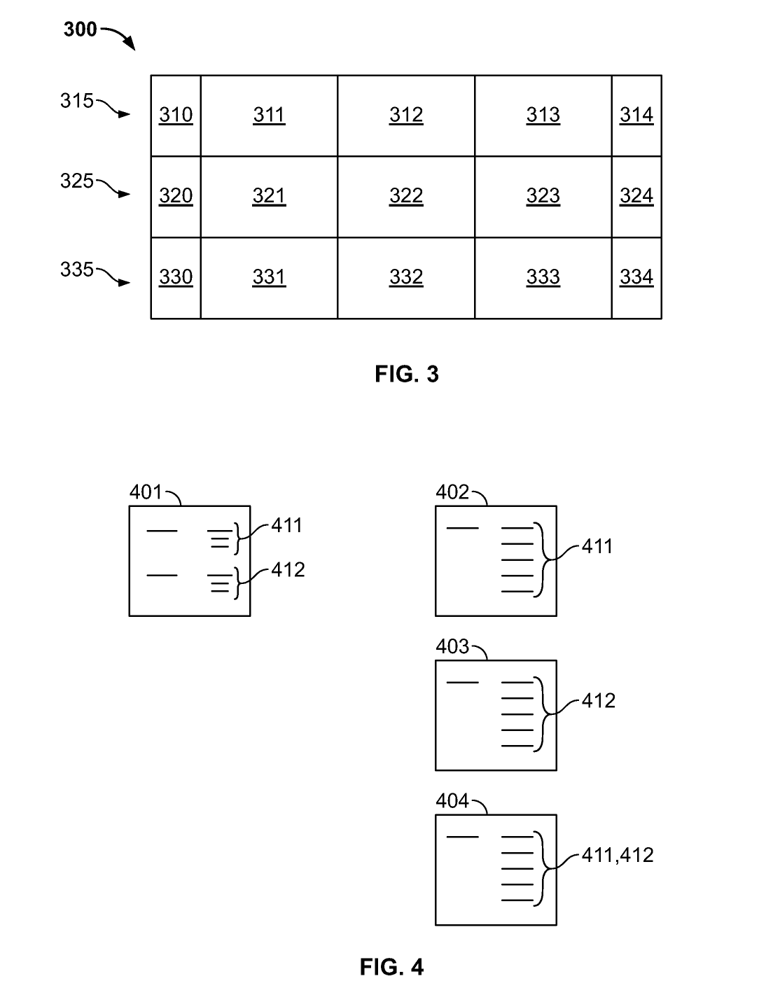

FIG. 3 shows a stack of security bit strings 315, 325, and 335. This embodiment shows that bit strings may be stacked upon one another and read as a two-dimensional array rather than a linear string. The stack of bit strings may be created by a key system or by a lock system. In some embodiments the key system may contain multiple transferable keys and may create this stack of codes from those keys. In embodiments, the lock system may receive bit streams from multiple key systems and may create the stack of bit strings from these strings. In embodiments a lock system may be programmed such that multiple tumbler codes must be read from different transferable tumbler code carriers in order for the lock system to open. These tumbler codes may need to be read simultaneously or in sequence in order for the lock system to open. Other criteria described within or otherwise may also be necessary.

As can be seen in FIG. 3, the security bit strings 315, 325, and 335 have header fields 310, 320, and 330; have access criteria fields, 311, 321, and 331; have tumbler codes 312, 322, 332; have encryption key fields 313, 323, and 333; and have footer fields 314, 324, and 334. Other fields may also be used in each bit string. In embodiments, when the stack of bit strings is created, a lock system may only read from certain bit strings and may ignore others depending upon the instructions being carried out by the lock system. For example, in the embodiment of FIG. 3, only bit stream 315 and 335 may be read by a lock system while bit stream 325 may be ignored or discounted by a lock system reading the codes.

FIG. 4 shows tumbler code data as may be used in a transferable tumbler code carrier system. Memory of a transferable tumbler code carrier 401 may contain data arrays 411 and 412. These data arrays may be used to store unique tumbler codes that may be used to open different lock systems. The memory 402-404 of the lock systems may each contain data arrays 411-413 of code. In embodiments, when a lock system matches an internal data array with a data array from a transferable key, the lock system may authorize access consistent with the access criteria associated with the code.

In FIG. 4, tumbler codes in tumbler code carrier 401 match with codes in code carriers 402, 403 and 404. Thus, the locks associated with code carriers 402, 403, and 404 may open upon receiving some or all of the matching data arrays 411-412 from the code carrier 401. Data arrays may also be used for master tumbler code carriers as well as satellite tumbler code carriers. In embodiments the master carrier, e.g. carrier 401, may contain an array of tumbler codes while the satellite carriers, e.g. carriers 402-404, may contain a bit string of tumbler codes. The array of tumbler codes of the master carrier may be used by a key system to open several locks or to open a single lock as well. Code carriers 401 and 402 as well as 401 and 403 may be considered mated pairs of code carriers while code carriers 402 and 403 may not be because they do not share the same security bit strings, i.e. 411 and 412.

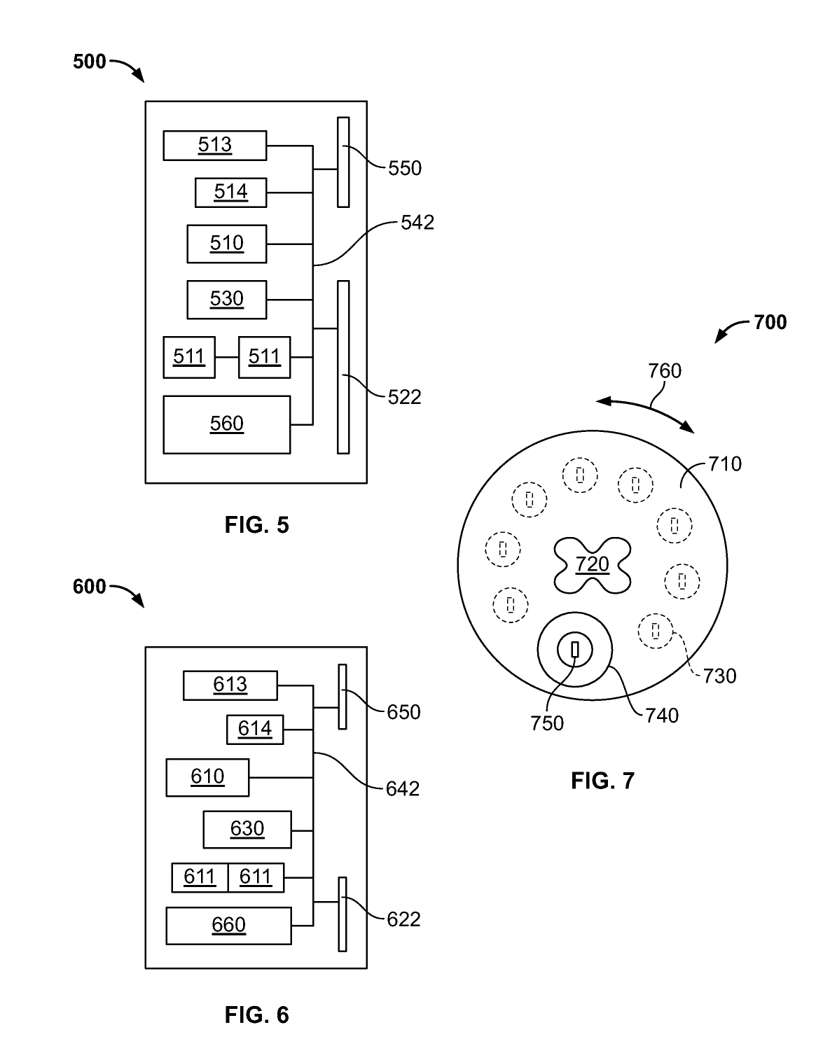

FIG. 5 is a component schematic of a reconfigurable security key system 500 as may be used in embodiments of the invention. The key system 500 is shown with a bus 542 connecting an RF antenna 550, a tumbler code interface 522, a power source 560, processors 511, an encryption module 530, a transceiver 510, input/output logic 514, and memory 513. The tumbler code interface 522 may be a port for physically receiving a transferable tumbler code carrier or other type of mechanism for communicating with a transferable tumbler code carrier. Codes may be read to and from a transferable tumbler code carrier in communication with the interface 522. The transceiver 510 may be used to send and receive encrypted signals through the antenna 550 while the I/O logic 514 may be used to drive or control user interfaces such as keys and a video screen. The encryption logic module 530 may be used to encrypt the communications sent over the antenna as well as to encrypt and decode the tumbler codes themselves. The key system 500 may be a standalone unit as well as part of another device, such as a cellular phone or key fob for an automobile. Thus, in use, the key system 500 may be programmed by communicating with a code carrier and may then use the security bit string or other mechanism to lock and unlock lock systems receptive to the bit string or other mechanism. Non-limiting examples of electronics that may be configured to include a key system include cell-phones, personal digital assistants, and other hand-held electronics.

FIG. 6 is a component schematic of a reconfigurable security lock system 600 as may be used in embodiments of the invention. The lock system 600 is shown with a bus 642 connecting an RF antenna 650, a tumbler code interface 622, a power source 660, processors 611, an encryption module 630, a transceiver 610, input/output logic 614, and memory 613. The tumbler code interface 622 may be a port for physically receiving a transferable tumbler or other type of mechanism for connecting with a transferable tumbler. Codes may be read to and from a transferable tumbler code carrier connected to the interface 622. The transceiver 610 may be used to send and receive encrypted signals through the antenna 650 while the I/O logic 614 may be used to drive or control user interfaces such as keys and a video screen. The encryption logic module 630 may be used to encrypt the communications sent over the antenna as well as to encrypt and decode the tumbler codes themselves. The lock system 600 may be a standalone unit as well as part of another device, such as an ignition or other lock system on an automobile. Upon receiving a security bit code from a mated code carrier of a key, the lock may open to allow access.

FIG. 7 is a schematic of a lock system 700 from a reconfigurable security system in accord with embodiments of the present invention. The lock system 700 is shown with a rotating outer disk 710 having a circular tumbler access port 740. This port 740 may be rotated by spinning rotation knob 720. As the port 740 is rotated, the removable mechanical transferable tumblers may be accessible though the port 740. The removable mechanical transferable tumblers 730 may contain a key hole 750 and may be removable from the lock system 700. By having multiple tumblers in the lock system 700, multiple keys may be used to open the lock system. A user may rotate the knob 720 to access the tumbler associated with the user's key in order to open the lock. As with other embodiments described herein, the lock system 700 may restrict access of certain keys to certain times or days. Likewise, the number of times a key may open the lock system 700 may also be counted and limited or otherwise controlled.

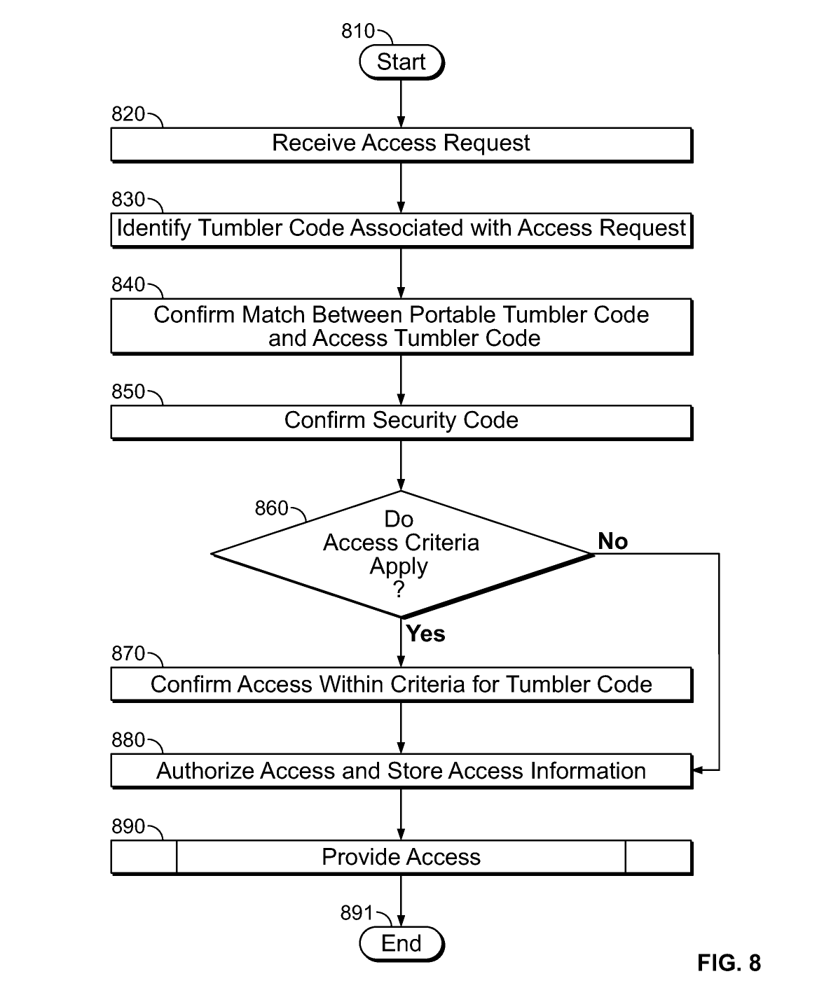

Exemplary method embodiments are provided in FIG. 8. A reconfigurable lock system or other system may carry out some or all of the actions identified in FIG. 8. Other actions may also be added and the actions may be carried out in different order and simultaneously in certain embodiments. In FIG. 8, as shown at 820, a lock system may receive a request for access from a reconfigurable key system or other device. The reconfigurable lock system, as shown at 830, may review the tumbler access codes it has stored in memory or may review the tumbler codes of the transferable tumblers positioned in ports of the lock system. As shown in 840, a match may be confirmed between the code received and the code accessed by the lock system. An additional step may also be carried out where a security code 850 is confirmed. This security code confirmation may include reviewing any access criteria associated with the tumbler code. The access criteria may be stored within a security bit string as described above or may be stored and retrieved through other methods as well. As shown at 860, if access criteria apply, a test may be performed at 870 to determine if access should be authorized. Conversely, if no access criteria apply, access may be authorized as shown at 880. In addition to authorizing access at 880, information such as time of access and by whom may also be stored. Once access is authorized, access may be provided, as shown at 890. As noted, additional steps and actions may be included or excluded from those described in this description of FIG. 8.

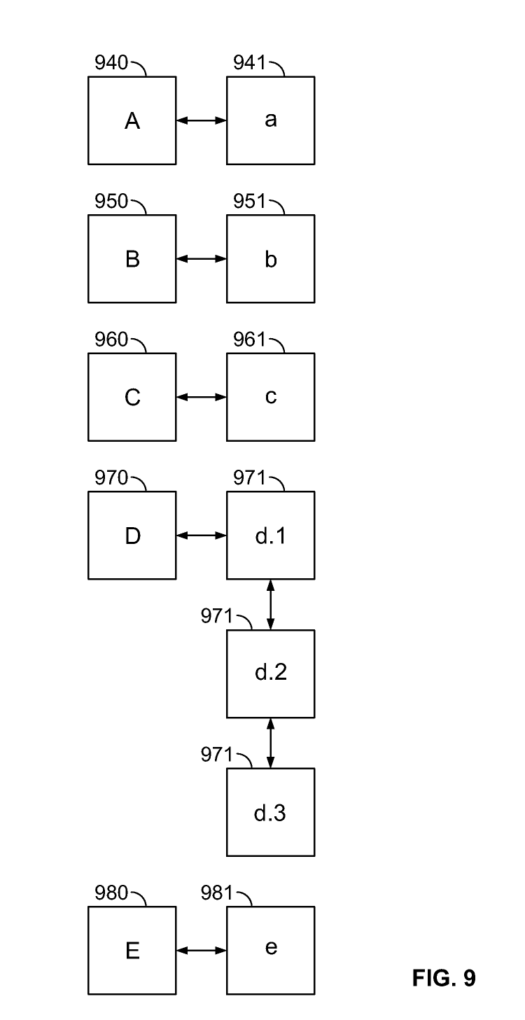

FIG. 9 shows pairs and groups of mated transferable tumbler code carriers. Primary or master tumbler code carriers are shown at 940, 950, 960, 970, and 980 while secondary or satellite tumbler code carriers are shown at 941, 951, 961, 971, and 981. As can be seen, the carriers can be mated to another carrier (e.g. 940-941; 950-951) and to a group of carriers (e.g., 970-971). The carriers 940 and 941 may contain identical or linked tumbler codes that can be viewed and matched by key systems and lock systems using or configured by the transferable tumbler code carrier. In use, code carrier 940 may be used to program or configure a key system and code carrier 941 may be used to program or configure a lock system. Once so configured or programmed, the key system may then be used to open and close the lock system. Likewise, code carrier 970 may be used to configure or program a key system and code carriers 971d.1-971d.3 may be used to configure or program several lock systems. These lock systems configured with 971d.x may then be opened or closed by the key system programmed by carrier 970. As noted, identical matches of tumbler codes may be needed to open locks or locks may be opened by linked tumbler codes as well. In other words, the tumbler codes may not be an exact match but may be close enough to allow access. In one example 14 of 16 bits of an access code may match and this may be enough to consider the codes linked and to allow access. By allowing less than identical matches to open lock systems, some keys may be considered master keys opening entire groups of locks while other keys, which contain 14 matching bits, may have more limited access to locks and be able to open a particular sub-set of locks.

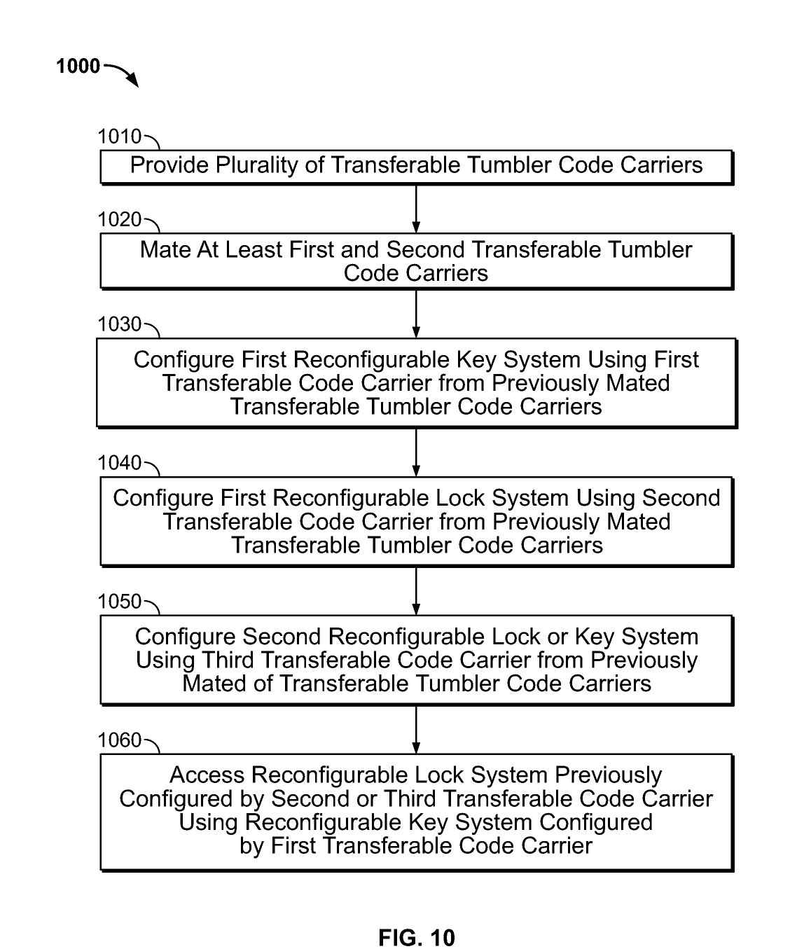

FIG. 10 shows a method as may be employed in accord with embodiments of the present invention. Such methods may include some or all of the items of FIG. 10. As shown at 1010 the method may include providing a plurality of transferable tumbler code carriers. These carriers may be provided in sets, groups, and in one or more pairs. The carriers may be mated, and/or color coded in such a way as to designate the association with one another. These carriers may be similar or identical to those shown at 140 in FIG. 1. They may also have other configurations as well. Containing internal memory and/or storage, the tumbler code carriers may be mated into pairs and/or sets. 1020 shows this, as it states that a first and second transferable tumbler code carrier are mated. This mating may include loading similar or identical tumbler codes 212 onto the carriers 140 as well as linked encryption key fields 213. Likewise access criteria 211 may also be similar or identical between the first and second transferable tumbler code carriers. At 1030 a first reconfigurable key system may be configured using the first transferable code carrier from the mated set, group or pair of transferable tumbler code carriers. The key system may be configured by inserting the tumbler code carrier into the key system and leaving it there as well as inserting and removing the tumbler code carrier from the reconfigurable key system. As discussed herein, the security bit string and/or other information from the transferable tumbler code carrier may also be transferred to the key system using other methods such as Wi-Fi and Bluetooth transfer protocols.

At 1040 a first reconfigurable lock system is configured using the second transferable code carrier from the previously mated transferable tumbler code carriers. As with the reconfigurable key system, the reconfigurable lock system may temporarily, for some duration, or permanently store the transferable code carrier. The security bit string may be used to associate the reconfigurable lock system with a certain reconfigurable key system. As can be seen, this association may be caused by the mated first and second transferable tumbler code carriers that have been inserted or are otherwise associated with each of the key system and the lock system.

As shown at 1050, a second reconfigurable lock system and key system may also be configured using a third transferable code carrier from previously mated transferable tumbler code carriers. Consequently, as explained herein, the first and second transferable tumbler code carriers may serve to associate additional key or lock reconfigurable systems. Referring back, 970 and 971 of FIG. 9 show a set of mated transferable tumbler code carriers. As can be seen in FIG. 9, 970 D has three associated tumbler code carriers 971 d.x. Each of these mated or associated tumbler code carriers may be placed in various keys and or lock systems such that 970 D may be used to open multiple locks mated with 971 d.x and vice versa.

At 1060, of FIG. 10, access to a reconfigurable lock system previously configured by a second or third transferable code carrier using a reconfigurable key system configured by the first transferable code carrier is shown. Accordingly, as noted, a key system holding a first transferable code carrier may be used to open second and third lock systems that themselves have been configured by or contain mated second or third transferable code carriers.

In an example, a plurality of transferable tumbler code carriers 140 may be placed in the communication ports 113 of the tumbler code configuration device 110 of FIG. 1. These tumbler code carriers 140, which have stored therein security bit strings 200, may be programmed by a user of the tumbler code configuration device 110. This programming may be carried out by entering in specific access codes on the push pads 112 of the tumbler code configuration device 110. This programming may be carried out by other methods as well, including random encryption of tumbler codes 212 within the security bit string 200 and permutations thereof. Once configured, the transferable tumbler code carriers 140, resident in the communication ports 113, may be considered to be made. Examples of these mated carriers are shown in FIG. 9.

A user of the reconfigurable security system 100 may then take these tumbler code carriers and place them within reconfigurable key systems 130 and reconfigurable lock systems 120. These reconfigurable key systems 130 or reconfigurable lock systems 120 may read the security bit strings 200 stored in the memory 141 of the transferable tumbler code carriers 140 and create an array of security bit strings 300 as shown in FIG. 3. Accordingly, when access is to be provided by the lock system 120 the lock system may read its internal memory and scan the arrays 300 to determine whether a specific key system 130 should be given access.

Likewise, the reconfigurable key system may store one or more data arrays for 411, 412. These data arrays may contain security bit strings 200 such that the reconfigurable key system 130 may be used to open multiple lock systems. These lock systems may be used to secure various items such as real property, personal property, and electronic networks.

In order to read the security bit strings used in its internal array of stored security bit strings 300, the reconfigurable lock and key systems may include encryption modules 530 and 630. These encryption modules may use various protocols and encryption schemes to protect the information on the security bit string in its entirety as well as individual information in the various fields of security bit string. These encryption modules, may use 64-bit and 128-bit encryption schemes. Other encryption schemes may be used as well. Likewise, nonstandard encryption schemes may also be used.

In addition to providing access, the reconfigurable security system in this example as well as in others, and as noted above, may also provide selected access to various users. This selected access may be predicated on time, days, and number of entries. Other criteria may be used as well.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process.

Further modifications to the methods and systems embodying the invention include having the tumbler code associated with a particular mated pair of tumbler code carriers where the tumbler code may be a specific static code, much like what would be represented by a physical key's permanent teeth configuration or a particular memorized password. This tumbler code may be transmitted to the lock system whenever access is being requested and may be protected from acquisition by ‘eavesdroppers’ by an encryption algorithm which exists independent of the actual code. Likewise, the tumbler code may represent a large, meaningfully inexhaustible, set of codes, whereby the key system would most likely never transmit the same code twice, and the lock system would not likely accept the same code twice, thus providing security against eavesdropping theft of the code(s). The use of this functionality may include encryption methods for rolling codes where future codes are transmitted from the receiver after receiving an encryption code from a key system. In embodiments, if a particular key-adapted tumbler code carrier was mated to multiple lock-adapted tumbler code carriers, the latter might contain sub-sets of the code set contained in the former, where none of the codes in each sub-set would match the ones in the others. This selective transfer of codes may provide for controlled access by master keys and satellite keys where master keys may open a greater number of locks than satellite keys.

Additionally, in embodiments, the tumbler code communication between a key system and lock system, which is meant to verify that the key system has access authority, may consist of a three part conversation. Here, a series of codes contained by two relevant tumbler code carriers may be a series of connected code pairs—one serving as a query and the other serving as the only correct answer to that specific query. Rather than the key system transmitting a stored tumbler code and the lock system verifying it as valid—the key system may initially transmit a plain request for access, which the lock system would recognize and respond to by choosing a particular question code from the series and transmitting it to the key system, expecting and requiring the unique answer code that was associated with that question code (on both tumbler code carriers) in response. This conversation may take place automatically, once an access request was made, and it may happen essentially instantaneously. In this way, a stolen (tumbler) answer code would be of no use because it would only be the right answer if the lock system asked a particular question, which it would not do again. This type or other encryption may or may not be used to provide additional security.

Another possible aspect of embodiments, would be for a properly configured key system to be allowed to engage a properly configured lock system—to lock it as opposed to unlock it. For instance, a user might be able to use some key systems to lock the door to a residence from their car as they're leaving, because they forgot to lock it as they exited or because they needed to wait for someone else to exit the residence or for some other reason. Further, in some uses, a request for access from a key system might carry with it directions for the lock system to relock itself—either on a particular event, e.g. the door being closed again, or after a certain period of time, e.g. 2 minutes after it unlocked. The key system might be easily configurable so that it automatically sent such directions, or such that it didn't. Further, it might be configurable such that it automatically sent such directions to some of the lock systems it was associated with, but not to others.

Additionally, in some uses, rather than actually locking or unlocking in response to communications from key systems, a lock system may simply register those communications so as to keep track of certain conditions, e.g. whether or not a particular user is present or proximate to the lock system. Those conditions might be used by the lock system to make independent decisions about locking or unlocking, or used to make access decisions with regard to requests from other key systems. For instance, an office building's locking system might be configured to receive an affirmative communication from each authorized user's key system as they enter it. If it is locked, that communication might cause it to unlock. If it is already unlocked, that communication might just be noted as indicating the presence of the user. The lock system might also be configured to receive an affirmative communication from each authorized user when they leave. The communication might only cause the lock system to lock the premise if no other authorized users were noted as currently being present. Further, the noted presence or absence of a particular authorized user, or combination of authorized users, might be a condition for granting access to other users, or to a particular other user or key system.

Additionally, in some uses, the noted presence of an authorized user (a condition initiated by a key system communication to unlock or register presence) may cause the lock system to ‘ping’ that user's key system at regular intervals (e.g. every 15 minutes) to confirm and note continued presence, with that information being used as a factor in independent lock and unlock decisions, or as a factor in making particular access decisions with regard to requests from other key systems. The lock system could include not only mechanisms proximate to the area of entry, but the interconnected computer networks in a building or residence—it may tie in and use them to confirm the ongoing presence of a multitude of key systems through various forms of wireless communication.

Another possible aspect of embodiments of the invention may include having the tumbler code carriers adapted: (1) such that a key system could either retrieve the necessary information from them and store it so as to have no further need of them, or remain in contact or connection with them and retrieve the necessary information on an as needed basis; or (2) such that a key system had to retrieve and store the necessary information from them so as to have no further need of them; or (3) such that a key system could not retrieve and store the necessary information from them, but rather had to remain in contact or connection with them in order to use their information on an as needed basis. The latter adaptation may be important in a use where someone wished to temporarily loan a key-adapted tumbler code carrier to someone to easily give them access to a range of lock systems, but wanted to be sure that that person wouldn't have an ongoing means of access once the tumbler code carrier was returned. Here, this may be accomplished by having the tumbler code carriers adapted such that only a portion of their information could be read in a certain time interval, or such that they could keep track of what information was read in order to later communicate (and invalidate) that information to lock systems.

Embodiments may also include lock systems that may have a separate means of allowing access to their ‘owners’ to reconfigure them, such that having a key system associated with a tumbler code carrier which granted access to whatever the lock system is protecting doesn't necessarily provide the ability to reconfigure the lock system. For instance, a lock system installed on a door might have a small compartment that could be locked and unlocked with a physical key such that only the person with that physical key could change the tumbler code carriers connected to the lock system in that small compartment, or use the communication port in that small compartment to transfer tumbler codes from tumbler code carriers to the lock system, or otherwise reconfigure the lock system. Or, a separate passcode or access code may have to be transmitted to a lock system in order to be allowed to reconfigure it, including to configure it to accept or reject tumbler codes consistent with particular tumbler code carriers. While a multitude of key systems might have access authority for a particular lock system at a given point, only one of two of those key systems may have authority to access the configuration of the lock system and to alter it.

The many locks described above and explained throughout may be configured such that a single key provides access. These locks may be vastly different in embodiments such that a single key may provide access to a home, a vehicle, a computer system, particular portions of an office building, and even a hotel mom, all with the same key. Further, this key may provide access to some of those on a temporary basis, or under particular conditions, while at the same time providing access to the others without those same limitations. Still further, the actual composition of the various lock-adapted tumbler code carriers associated with the key-adapted tumbler code carrier might be different. The lock-adapted tumbler code carriers may function differently with regard to how they transfer their information to the various lock systems, as those locking systems are adapted to communicate with tumbler code carriers in different ways.

Embodiments of the lock systems may vary a great deal with regard to composition and functionality (e.g., some might have very limited functionality and be relatively inexpensive, while some might offer more functionality than one might realistically use). The same may be true of the key systems. These key systems may vary tremendously but share the common trait that they are all capable of communicating with tumbler code carriers in some way, e.g., via an ongoing physical connection, via a physical connection incident, and via one of several wireless methods.

In embodiments, a single lock system may be configured so that many key systems, by using information from appropriate tumbler code carriers, can access it and can access it under different conditions—time and otherwise. Further, a lock system might be configured such that any particular key system or combination of key systems might have its access authority removed at any time and at the discretion of the lock system's ‘owner’, without having any effect on the ongoing access authority of other key systems. The reverse may also be included in embodiments. Here, a lock system may be associated with several keys by using several transferable tumbler code carriers in the lock system. Thus, in embodiments, locks may learn to fit keys, rather than keys learning to fit locks, as has traditionally been the way of the world—a lock might learn the language of all the keys that are to have access, rather than all the keys that are to have access having to learn the language of the lock.

In embodiments, a user of a reconfigurable key system may have multiple satellite tumbler code carriers adapted to be inserted into or used to program reconfigurable lock systems where one or more of the satellite tumbler code carriers may contain only a portion of the tumbler codes, or other access information, that is contained in the master tumbler code carrier that have been used to program the user's key system. The portion of the tumbler codes contained by each satellite tumbler code carrier may be unique among the satellite tumbler code carriers. In this way, the user of the key system may, at various times, hand out satellite tumbler code carriers to owners of lock systems for which the key system user may need future access.

The need for future access may be temporary in nature, as for a pre-determined period of time or an, as yet, undetermined period of time. The need for future access may also be conditioned in other ways or contingent on, as yet, undetermined factors. As the satellite tumbler code carriers that may be distributed by the user of a key system may contain only a unique portion of the tumbler codes contained by the master tumbler code carrier used to program the key system, a person to whom a satellite tumbler code carrier may be distributed may not be able to use the tumbler codes contained on that satellite tumbler code carrier to somehow gain unauthorized access to a lock system which has been programmed with a different satellite tumbler code carrier, even if that different satellite tumbler code carrier is associated with the same master tumbler code carrier.

In use, embodiments, such as the preceding one, may allow someone operating a business which requires them to have access to customers' homes, to be able to distribute to each new customer or prospective customer a satellite tumbler code carrier which the customer may use to program the lock system in their home such that the business operator could gain access under the conditions, and at the times, the home owner desired. The home owner may feel comfortable that programming their lock system thusly would only allow access by the business operator or someone acting on their behalf. When the access was no longer needed, the home owner may re-program their lock system, feeling comfortable that further access on the part of the business operator would not be possible. The satellite tumbler code carriers may be considered as disposable by the business operator, such that customers or prospective customers may be instructed that they could dispose of them once they were no longer needed, or in the event that, as it turned out, they were never needed at all. The continued existence of the satellite tumbler code carrier may cause little to no security risk to the business operator or any of their other customers.

In embodiments or uses, reprogramming a key system or lock system may only require that a user insert a tumbler code carrier into, or remove a tumbler code carrier from, the key system or lock system. In other embodiments or uses, reprogramming may involve different or additional user actions, such as entering information or selections through a keypad integrated into the key system or lock system.

In embodiments, a system may comprise a mated set of tumbler code carriers containing corresponding identification information with one or more reconfigurable lock system and one or more reconfigurable key system. In this or other embodiments, one or more of the tumbler code carriers from the mated set of tumbler code carriers may be adapted to communicate with one or more reconfigurable key systems and one or more of the reconfigurable key systems may be configured to identify information it retrieves from the tumbler code carrier to grant access using the identified information. Still further, in embodiments, one or more of the tumbler code carriers from the set of tumbler code carriers may be adapted to communicate with one or more reconfigurable lock systems, wherein one or more of the reconfigurable lock systems may be configured to identify information it retrieves from the tumbler code carrier to confirm that the tumbler code carrier is mated to another tumbler code carrier whose identifying information has been retrieved and to further confirm that a reconfigurable key system has access authority for the reconfigurable lock system.

The corresponding structures, material, acts, and equivalents of any means or steps plus function elements in the claims are intended to include any structure, material or act for performing the function in combination with other claimed elements. The description of embodiments of the present invention have been presented for purposes of illustration and description, but is not intended to be exhaustive or limited to the invention in the form disclosed. Many modifications and variations will be apparent to those of ordinary skill without departing from the scope and spirit of the invention. These embodiments were chosen and described in order to best explain the principles of the invention and the practical application, and to enable others of ordinary skill in the art to understand the invention for embodiments with various modifications as are suited to the particular use contemplated.

What is claimed is:

1. A system comprising:
a mated set of tumbler code carriers containing corresponding identification information;
wherein, one or more of the tumbler code carriers from the mated set of tumbler code carriers is adapted to communicate with one or more reconfigurable key systems,
wherein, one or more of the tumbler code carriers from the mated set of tumbler code carriers is adapted to communicate with one or more reconfigurable lock systems,
wherein the corresponding identification information on the mated set of tumbler code carriers includes a matching tumbler code,
the matching tumbler code copyable from a tumbler code carrier to a reconfigurable key system for retention by the key system,
the matching tumbler code copyable from a tumbler code carrier to a reconfigurable lock system for retention by the lock system.

2. The system of claim 1 wherein the mated set of tumbler code carriers includes a first and second and third tumbler code carrier, each tumbler code carrier having internal memory storing therein a security bit string having an identical tumbler code.

3. The system of claim 1,
wherein a tumbler code carrier from the mated set is designated as a lock-adapted tumbler code carrier and a tumbler code carrier from the mated set is designated as a key-adapted tumbler code carrier,
wherein the lock-adapted tumbler code carrier and key-adapted tumbler code carrier each contain identification information corresponding to the other, the information used by a reconfigurable key system and a reconfigurable lock system to open and close the reconfigurable lock system.

4. The system of claim 3,
wherein the identification information is a tumbler code of a security bit string.

5. The system of claim 4,
wherein the tumbler code is generated using an encryption protocol identified in the security bit string.

6. A security device comprising:
a bus;
a processor in communication with the bus;
a power source in communication with the bus;
a transceiver in communication with the bus;
a tumbler code carrier interface in communication with the bus;
a memory in communication with the bus,
the memory having instructions stored therein, which when executed, cause the processor to process one or more tumbler codes received via the tumbler code carrier interface, the received one or more processed tumbler codes having a corresponding mated tumbler code stored on a different device,
the processing including reading the tumbler code, storing the tumbler codes, and at least either broadcasting a specific stored tumbler code via the transceiver to a lock or comparing a tumbler code received though the transceiver to tumbler codes stored in memory.

7. The device of claim 6 further comprising a lock in communication with the bus, the lock having an open configuration and a closed configuration,
wherein the lock is configured to be in an open configuration or a closed configuration based on instructions generated by the processor,
the instructions being generated by the processor when the processor identifies a match between a first tumbler code received via the transceiver and a second tumbler code stored in memory,
wherein the first tumbler code and the second tumbler code were previously resident on a mated pair of tumbler code carriers,
wherein the second tumbler code was transferred to memory via the tumbler code interface and wherein the first tumbler code was received from an alterable key system.

8. The device of claim 6, wherein the tumbler code carrier interface is configured as a port for a nonvolatile memory storage device having exposed contacts.

9. The device of claim 8, wherein the nonvolatile memory storage device is a master transferable tumbler code carrier having an array of security bit strings stored in memory, the array including a plurality of tumbler codes and a plurality of encryption key fields.

10. The device of claim 6, wherein the tumbler code carrier interface is in communication with a satellite transferable tumbler code carrier,
the satellite transferable tumbler code carrier being mated with a master transferable tumbler code carrier,
wherein the master code carrier and the satellite code carrier contain identical tumbler codes, the tumbler codes copyable to the memory of the device.

11. A security system comprising:
a tumbler code configuration device having
an electronic control system, and
one or more communication ports in communication with the electronic control system,
the electronic control system adapted to communicate with transferable tumbler code carriers via one or more of the communication ports,
the electronic control system adapted to send a first tumbler code to a first transferable tumbler code carrier via a communication port of the configuration device, the first code carrier adapted for communication with a reconfigurable key system, and
the configuration device adapted to send the first tumbler code to a second transferable tumbler code carrier via a communication port of the configuration device, the second code carrier adapted for communication with a reconfigurable lock system.

12. The security system of claim 11 wherein one or more of the communication ports of the configuration device is adapted for
simultaneous mechanical contact with multiple transferable tumbler code carriers or
wireless communication with multiple transferable tumbler code carriers.

13. The security system of claim 11 further comprising:
a reconfigurable key system having an electronic control system and one or more communication ports,
at least one of the communication ports adapted for communication with a transferable tumbler code carrier,
at least one of the communication ports adapted for communication with a reconfigurable lock system,
the reconfigurable key system further adapted to read a tumbler code from a transferable tumbler code carrier and to send the tumbler code to a reconfigurable lock system via a communication port.

14. The security system of claim 13 wherein the reconfigurable key system is further adapted
to store a plurality of distinct tumbler codes received from one or more transferable tumbler code carriers, and
to send a selected stored tumbler code to a reconfigurable lock system after receiving an unlock instruction.

15. The security system of claim 11 further comprising:
a reconfigurable lock system having an electronic control system and one or more communication ports,
at least one of the communication ports adapted to receive instructions from the reconfigurable key system of claim 13.

16. The security system of claim 15 wherein the electronic control system of the reconfigurable lock system is adapted to authorize access of a structure, device, machine or computer secured by the reconfigurable lock system after confirming a match between a stored tumbler code and a tumbler code received from a reconfigurable key system.

17. The security system of claim 16 wherein the machine is a motor vehicle.

18. The security system of claim 11 further comprising
a reconfigurable lock system having an electronic control system and one or more communication ports,
at least one of the communication ports adapted to receive instructions from a reconfigurable key system,
wherein the electronic control system is adapted to confirm a match between a tumbler code in a transferable tumbler code carrier resident at the reconfigurable lock system and a tumbler code received from a reconfigurable key system.

19. The security system of claim 18 wherein the electronic control system of the reconfigurable lock system is further adapted to limit access to a secured structure, device, machine or computer when, after reading an access code, confirming that access criteria designated by the access code is not satisfied.

20. The security system of claim 18 wherein the reconfigurable lock system has a plurality of communication ports and substantially each of the ports is configured to receive, read from, and removably retain a transferable tumbler code carrier.
